(19) United States
(12) Patent Application Publication
(10) Pub. No.: US 2018/0156124 A1
(43) Pub. Date: Jun. 7, 2018

(54) TURBINE ENGINE FRAME INCORPORATING SPLITTERS

(71) Applicant: General Electric Company, Schenectady, NY (US)

(72) Inventors: Jeffrey Donald Clements, Mason, OH (US); Ganesh Seshadri, Bangalore (IN); Mahendran Manoharan, Bangalore (IN); Ravikanth Avancha, Bangalore (IN); Aspi Rustom Wadia, Loveland, OH (US)

(21) Appl. No.: 15/366,841

(22) Filed: Dec. 1, 2016

(51) Int. Cl. F02C 7/20; F01D 25/28; F02C 3/06; F01D 5/02; F01D 9/04; F04D 29/32; F04D 29/54; F04D 29/52; F01D 25/24

(52) U.S. Cl. CPC F02C 7/20; F01D 25/28; F02C 3/06; F01D 5/02; F01D 9/041; F05D 2220/32; F04D 29/542; F04D 29/522; F01D 25/24; F05D 2240/90; F04D 29/324

(57) ABSTRACT

A frame apparatus for a turbine engine includes: a turbomachinery stage discharging into a downstream flowpath, the stage including a rotor carrying an array of axial-flow rotor airfoils; and a frame disposed downstream of the turbomachinery stage, the frame including: a support structure comprising at least one of a hub and an annular casing; an annular array of stationary struts carried by the support structure, each strut having an airfoil shape with spaced-apart pressure and suction sides extending between a leading edge and a trailing edge thereof, the stationary struts defining spaces therebetween; and the stationary struts defining spaces therebetween; and a plurality of splitters carried by the support structure, the splitters positioned in the spaces between the stationary struts, wherein at least one of a chord dimension of the splitters and a span dimension of the splitters is less than the corresponding dimension of the stationary struts.

### BACKGROUND OF THE INVENTION

This invention relates generally to gas turbine engines and more particularly to stationary frames in such engines.

A gas turbine engine includes, in serial flow communication, a compressor, a combustor, and turbine. The turbine is mechanically coupled to the compressor and the three components define a turbomachinery core. The core is operable to generate a flow of hot, pressurized combustion gases The core forms the basis for several aircraft engine types such as turbojets, turboprops, and turbofans.

Designers and engineers continually strive to produce gas turbine engines having greater output and lower fuel consumption. Newer gas turbine engine designs, including extensions of existing designs with uprated performance (i.e. “growth designs”), can have elevated turbine exit Mach numbers.

One problem with these designs it that they can lead to undesirable aeromechanical interaction between rotating airfoils and downstream frame structures.

### BRIEF DESCRIPTION OF THE INVENTION

This problem is addressed by a stationary turbine engine frame which incorporates splitter airfoils. The splitters are effective to locally reduce a bow wave effect on upstream airfoils.

According to one aspect of the technology described herein, a frame apparatus for a turbine engine includes: an axial-flow turbomachinery stage that discharges into a downstream flowpath, the stage including a rotor carrying an array of axial-flow rotor airfoils; and a frame disposed downstream of the turbomachinery stage, the frame including: a support structure comprising at least one of a hub and an annular casing; an annular array of stationary struts carried by the support structure, each of the struts having an airfoil shape with spaced-apart pressure and suction sides extending between a leading edge and a trailing edge thereof, the stationary struts defining spaces therebetween; and the stationary struts defining spaces therebetween; and a plurality of splitters carried by the support structure, the splitters positioned in the spaces between the stationary struts, wherein at least one of a chord dimension of the splitters and a span dimension of the splitters is less than the corresponding dimension of the stationary struts.

According to another aspect of the technology described herein, a gas turbine engine includes: a compressor, a combustor, and a turbine, at least one of the compressor and the turbine being an axial-flow device; wherein at least one of the compressor and the turbine includes an axial-flow turbomachinery stage that discharges into a downstream flowpath, the turbomachinery stage including a rotor carrying an array of axial-flow rotor airfoils; and a frame disposed downstream of the turbomachinery stage, the frame including: a support structure comprising at least one of an annular hub and an annular casing; an annular array of stationary struts carried by the support structure, each of the struts having an airfoil shape with spaced-apart pressure and suction sides extending between a leading edge and a trailing edge thereof, the stationary struts defining spaces therebetween; and the stationary struts defining spaces therebetween; and a plurality of splitters carried by the support structure, the splitters positioned in the spaces between the stationary struts, wherein at least one of a chord dimension of the splitters and a span dimension of the splitters is less than the corresponding dimension of the stationary struts.

### BRIEF DESCRIPTION OF THE DRAWINGS

The invention may be best understood by reference to the following description taken in conjunction with the accompanying drawing figures in which:

FIG. 1 is a schematic, sectional view of a prior art gas turbine engine;

FIG. 2 is an enlarged view of a portion of FIG. 1;

FIG. 3 is a schematic plan view of a rotor of the gas turbine engine of FIG. 1 and a downstream frame structure;

FIG. 4 is a front elevation view of a portion of a frame structure of the engine of FIG. 1;

FIG. 5 is a front elevation view of frame structure of FIG. 4 modified by the incorporation of splitters;

FIG. 6 is a view taken along lines 6-6 of FIG. 5;

FIG. 7 is a top plan view of the frame structure of FIG. 5;

FIG. 8 is a schematic plan view of an alternative frame structure; and

FIG. 9 is a schematic plan view of another alternative frame structure.

### DETAILED DESCRIPTION OF THE INVENTION

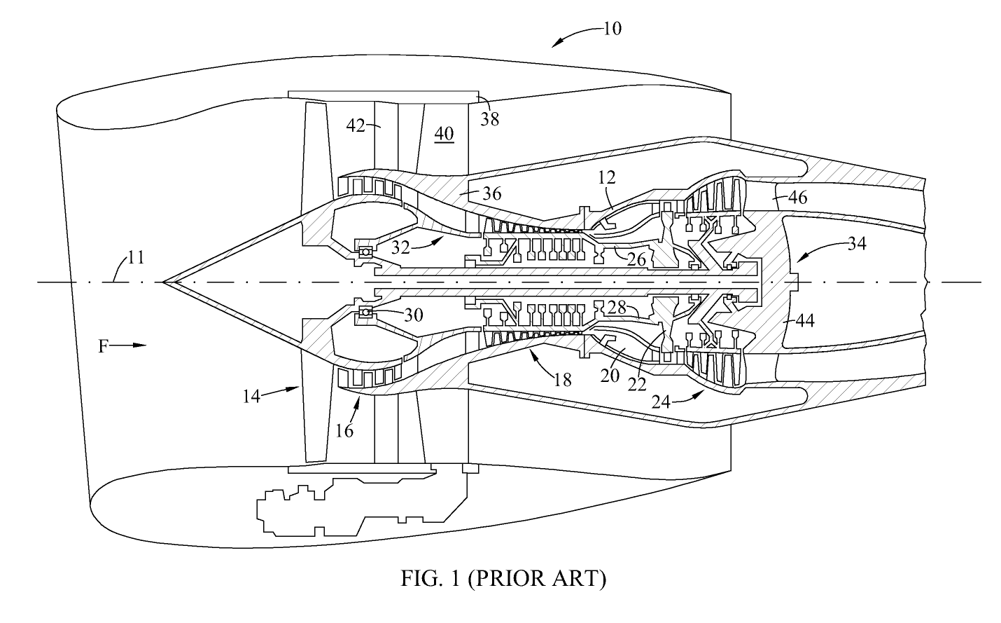

Referring to the drawings wherein identical reference numerals denote the same elements throughout the various views, FIG. 1 depicts an exemplary gas turbine engine 10. While the illustrated example is a high-bypass turbofan engine, the principles of the present invention are also applicable to other types of engines, such as low-bypass turbofans, turbojets, turboprops, etc. The engine 10 has a longitudinal center line or axis 11 and an outer stationary annular core casing 12 disposed concentrically about and coaxially along the axis 11.

It is noted that, as used herein, the terms “axial” and “longitudinal” both refer to a direction parallel to the centerline axis 11, while “radial” refers to a direction perpendicular to the axial direction, and “tangential” or “circumferential” refers to a direction mutually perpendicular to the axial and tangential directions. As used herein, the terms “forward” or “front” refer to a location relatively upstream in an air flow passing through or around a component, and the terms “aft” or “rear” refer to a location relatively downstream in an air flow passing through or around a component. The direction of this flow is shown by the arrow “F” in FIG. 1. These directional terms are used merely for convenience in description and do not require a particular orientation of the structures described thereby.

The engine 10 has a fan 14, booster 16, compressor 18, combustor 20, high pressure turbine 22, and low pressure turbine 24 arranged in serial flow relationship. In operation, pressurized air from the compressor 18 is mixed with fuel in the combustor 20 and ignited, thereby generating combustion gases. Some work is extracted from these gases by the high pressure turbine 22 which drives the compressor 18 via an outer shaft 26. The combustion gases then flow into the low pressure turbine 24, which drives the fan 14 and booster 16 via an inner shaft 28. The inner and outer shafts 28 and 26 are rotatably mounted in bearings 30 which are themselves mounted in a fan frame 32 and a turbine rear frame 34.

The fan frame 32 includes a central hub 36 connected to an annular fan casing 38 by an annular array of radially extending struts 40. An annular array of fan outlet guide vanes (“OGVs”) 42 extend across the fan flowpath just downstream of the fan 14. In this example, the OGVs 42 are aero-turning elements and the struts 40 serve as structural supports for the fan casing 38. In other configurations, a single row of airfoil-shaped elements perform both the aerodynamic and structural functions. The fan 14 and the OGVs 42 are one example of an apparatus within a gas turbine engine having a rotating airfoil row immediately upstream of a row of stationary struts.

The turbine rear frame 34 has a central hub 44 connected to the core casing 12 by an annular array of radially-extending struts 46. The low-pressure turbine 24 and the turbine rear frame 34 are another example of an apparatus in a gas turbine engine having a rotating airfoil row immediately upstream of a row of stationary struts.

While the concepts of the present invention will be described using the turbine rear frame 34 as an example, it will be understood that those concepts are applicable to any stationary structure within the engine 10 including a rotating airfoil row immediately upstream of a row of stationary struts. It will also be understood that the concepts described herein may be applied to other types of turbines other than gas turbine engines, referred to generically as “turbine engines”.

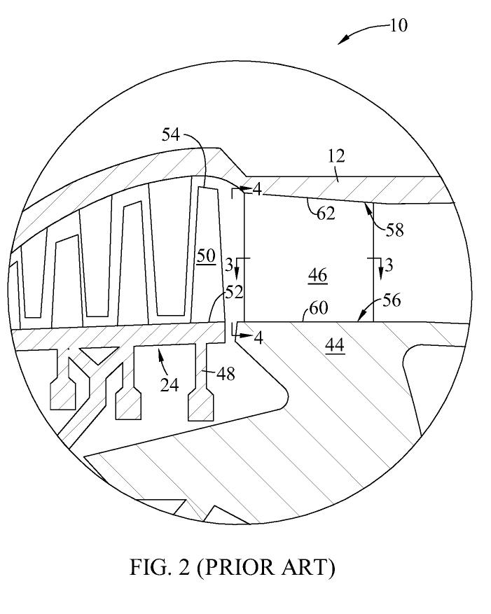

FIGS. 2-4 illustrate a portion of the low pressure turbine 24 and the turbine rear frame 34. The aft turbine stage includes a rotor 48 carrying a plurality of airfoil-shaped turbine blades 50 each extending from a root 52 to a tip 54. The airfoil-shaped struts 46 of the turbine rear frame 34 are bounded by the hub 44 and the casing 12, respectively. The hub 44 defines an annular inner flowpath surface 56, and the casing 12 defines an annular outer flowpath surface 58. Each strut 46 extends from a root 60 at the inner flowpath surface 56 to a tip 62 at the outer flowpath surface 58, and includes a concave pressure side 64 joined to a convex suction side 66 at a leading edge 68 and a trailing edge 70.

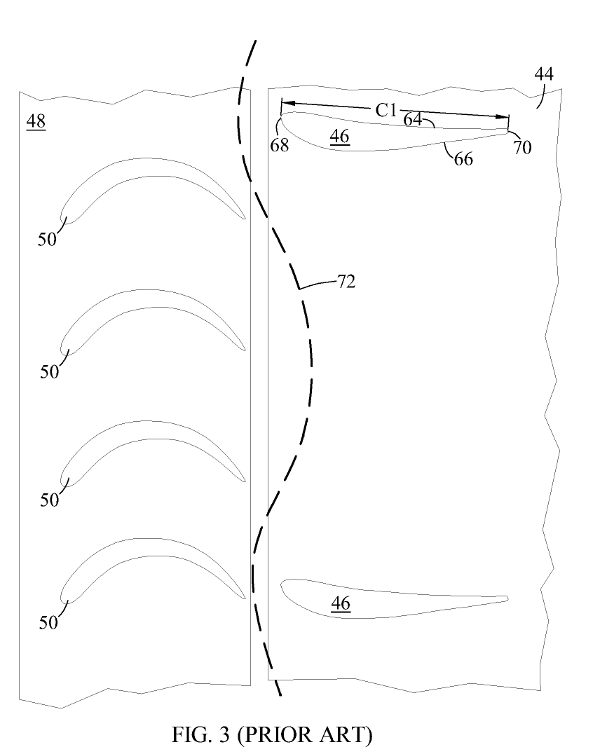

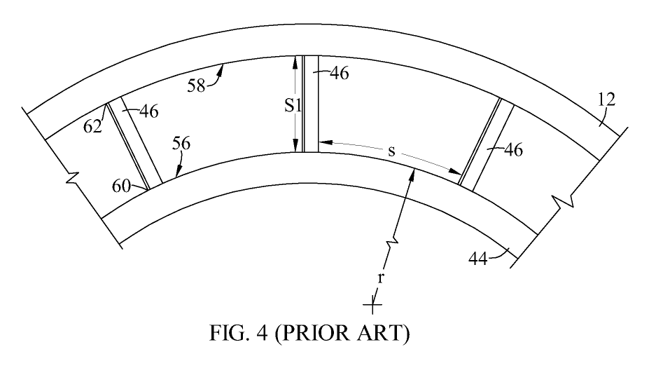

Each strut 46 has a span (or span dimension) “S1” (FIG. 4) defined as the radial distance from the root 60 to the tip 62. Depending on the specific design of the struts 46, its span S1 may be different at different axial locations. For reference purposes, the relevant measurement would be the span S1 at the leading edge 68. Each strut 46 has a chord (or chord dimension) “C1” (FIG. 3) defined as the length of an imaginary straight line connecting the leading edge 68 and the trailing edge 70. Depending on the specific design of the struts 46, its chord C1 may be different at different locations along the span S1. For purposes of the present invention, the relevant measurement would be the chord C1 at the root 60 or tip 62. The struts 46 are uniformly spaced apart around the periphery of the inner flowpath surface 56. A mean circumferential spacing “s” (see FIG. 4) between adjacent struts 46 is defined as s=2πr/Z, where “r” is a designated radius of the struts 46 (for example at the root 60) and “Z” is the number of struts 46. A nondimensional parameter called “solidity” is defined as c/s, where “c” is equal to the strut chord as described above.

During engine operation, a bow wave 72 (see FIG. 3) is generated immediately ahead of the leading edge 68 of each of the struts 46. The physical size of the bow wave 72 is known to be proportional to the spacing s between the struts 46. As the size of the bow wave 72 increases, its dimensions increase in both axial and tangential directions. The magnitude of the impact on the last stage rotor 48 from the downstream frame is related to the size of the bow wave 72.

As the turbine blades 50 rotate, they cut through the bow waves 72. The interaction of the bow waves 72 and the turbine blades 50 create a forcing function, resulting in aeroelastic effects in the turbine blades 50. Because the turbine blades 50 are cantilevered from the rotor 48, their effective stiffness at the outer portions near the tips 54 is less than at their roots 52; accordingly the aeroelastic effects are strongest near the tips 54. These effects can lead to excessive deflection, stresses, and potential cracking or component failure.

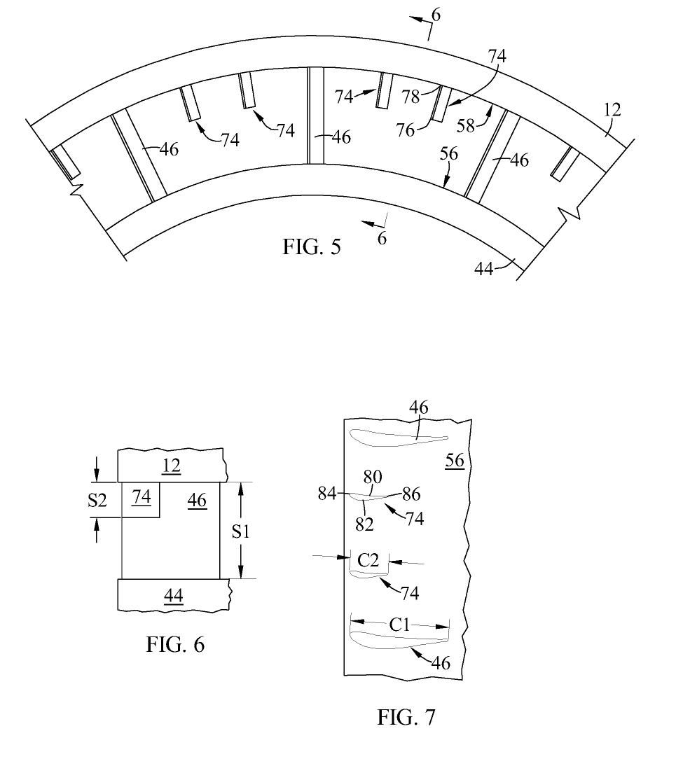

To reduce the strength of the bow waves 72, the turbine frame 34 may be provided with an array of splitters, as shown in FIGS. 5-7. In this example, an array of splitters 74 extend radially inward from the outer flowpath surface 58. Two splitters 74 are disposed between each adjacent pair of struts 46. In the circumferential direction, the splitters 74 may be evenly spaced or circumferentially biased between two adjacent struts 46. Each splitter 74 extends from a root 76 to a tip 78, and includes a concave pressure side 80 joined to a convex suction side 82 at a leading edge 84 and a trailing edge 86. As best seen in FIG. 6, each splitter 74 has a span (or span dimension) “S2” defined as the radial distance from the root 76 to the tip 78. Depending on the specific design of the splitter 74, its span S2 may be different at different axial locations. For reference purposes, the relevant measurement would be the span S2 at the leading edge 84. Each splitter 74 has a chord (or chord dimension) “C2” defined as the length of an imaginary straight line connecting the leading edge 84 and the trailing edge 86. Depending on the specific design of the splitter 74, its chord C2 may be different at different locations along the span S2. For purposes of the present invention, the relevant measurement is the chord C2 at the tip 78.

The splitters 74 function to locally increase the solidity and thereby reduce the strength of the above-mentioned bow waves 72. A similar effect could be obtained by simply increasing the number of struts 46, and therefore reducing the strut-to-strut spacing. An undesirable side effect of increased solidity is greater flow blockage. Therefore, the dimensions of the splitters 74 and their position may be selected to reduce bow wave strength while minimizing their surface area and resulting flow blockage and frictional losses. The axial position of the splitters 74 may be set to provide best performance and efficiency to suit a specific application. As an example, the splitters 74 may be positioned so that their leading edges 84 are located within a range from approximately 15% of the chord C1 axially forward of the strut leading edges 68, to approximately 30% of the chord C1 axially rearward of the strut leading edges 68.

The span S2 and/or the chord C2 of the splitters 74 may be some fraction less than unity of the corresponding span S1 and chord C1 of the struts 46. These may be referred to as “part-span” and/or “part-chord” splitters. For example, the span S2 may be equal to or less than the span S1. Preferably for reducing blockage and frictional losses, the span S2 is 50% or less of the span S1. As another example, the chord C2 may be equal to or less than the chord C1. Preferably for reducing blockage and frictional losses, the chord C2 is 50% or less of the chord C1.

For the purpose of reducing bow wave strength, the cross-sectional shape of the splitters is not critical. In a practical application, the splitters 74 may be streamlined to reduce aerodynamic drag and losses associated therewith.

The number, location, and configuration of the splitters 74 may be altered to suit a particular application. In the example shown in FIGS. 5-7, two splitters 74 are positioned between each pair of adjacent struts 46, equally spaced in the circumferential direction, and the splitters 74 have equal chord dimensions.

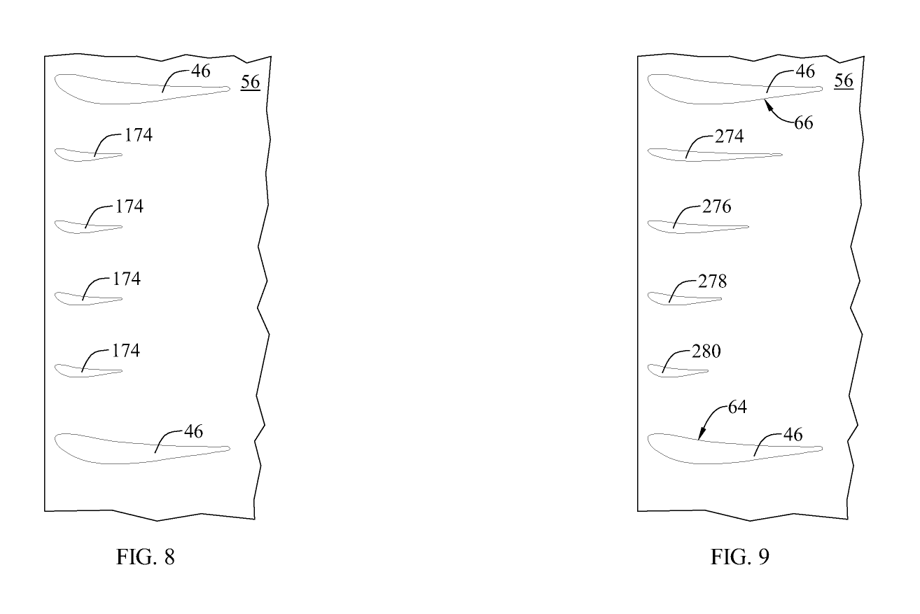

FIG. 8 illustrates an alternative embodiment. In this example, four splitters 174 are positioned between each pair of adjacent struts 46. the splitters 174 are equally spaced in the circumferential direction, and the splitters 174 have equal chord dimensions.

FIG. 9 illustrates another alternative embodiment. In this example four splitters 274, 276, 278, 280 are positioned between each pair of adjacent struts 46. the splitters 274, 276, 278, 280 are equally spaced in the circumferential direction. The splitters have a variable chord, with the chord of the splitter 274 closest to the suction side 66 of the strut 46 being the largest, tapering down to the chord of the splitter 280 being the smallest. This arrangement is useful because aerodynamic loading is strongest on the suction side 66 of the strut 46 and weaker adjacent the pressure side 64 of the adjacent strut; accordingly the splitters 274, 276, 278, 280 can be preferentially sized to mitigate bow wave strength while minimizing flow blockage and friction losses.

The turbine engine frame structure having the splitters described herein has advantages over the prior art. In particular, by applying part span splitters, the bow wave effect can be locally reduced allowing for improved durability and/or reduced spacing.

The foregoing has described a gas turbine engine with a splittered frame. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A frame apparatus for a turbine engine, comprising:
an axial-flow turbomachinery stage that discharges into a downstream flowpath, the stage including a rotor carrying an array of axial-flow rotor airfoils; and
a frame disposed downstream of the turbomachinery stage, the frame including:
a support structure comprising at least one of a hub and an annular casing;
an annular array of stationary struts carried by the support structure, each of the struts having an airfoil shape with spaced-apart pressure and suction sides extending between a leading edge and a trailing edge thereof, the stationary struts defining spaces therebetween; and
a plurality of splitters carried by the support structure, the splitters positioned in the spaces between the stationary struts, wherein at least one of a chord dimension of the splitters and a span dimension of the splitters is less than a corresponding dimension of the stationary struts.

2. The apparatus of claim 1 wherein the splitters have a streamlined shape.

3. The apparatus of claim 1 wherein each of the splitters has an airfoil shape with spaced-apart pressure and suction sides extending between a leading edge and a trailing edge thereof.

4. The apparatus of claim 1 wherein at least one of the spaces has two or more of the splitters positioned therein.

5. The apparatus of claim 4 wherein each of the struts has an airfoil shape with spaced-apart pressure and suction sides extending between a leading edge and a trailing edge thereof.

6. The apparatus of claim 5 wherein the splitters within the at least one space have a variable size, with the chord decreasing as the splitters extend further away from the suction side of one of the struts.

7. The apparatus of claim 1 wherein the splitter airfoils are positioned such that their leading edges are located within a range extending from approximately 15% of the chord dimension of the struts axially forward of the strut leading edges, to approximately 30% of the chord dimension of the struts axially rearward of the strut leading edges.

8. The apparatus of claim 1 wherein the span dimension of at least one of the splitter airfoils is 50% or less of the span dimension of the corresponding struts.

9. The apparatus of claim 1 wherein the chord dimension of at least one of the splitter blades at the tips thereof is 50% or less of the chord dimension of the corresponding struts at the tips thereof.

10. The apparatus of claim 1 wherein:
the support structure comprises a hub surrounded by an annular casing;
the struts extend between the hub and the casing; and
the splitters extend from the casing.

11. A gas turbine engine, comprising:
a compressor, a combustor, and a turbine, at least one of the compressor and the turbine being an axial-flow device;
wherein at least one of the compressor and the turbine includes an axial-flow turbomachinery stage that discharges into a downstream flowpath, the turbomachinery stage including a rotor carrying an array of axial-flow rotor airfoils; and
a frame disposed downstream of the turbomachinery stage, the frame including:
a support structure comprising at least one of an annular hub and an annular casing;
an annular array of stationary struts carried by the support structure, each of the struts having an airfoil shape with spaced-apart pressure and suction sides extending between a leading edge and a trailing edge thereof, the stationary struts defining spaces therebetween, the stationary struts defining spaces therebetween; and
a plurality of splitters carried by the support structure, the splitters positioned in the spaces between the stationary struts, wherein at least one of a chord dimension of the splitters and a span dimension of the splitters is less than the corresponding dimension of the stationary struts.

12. The apparatus of claim 11 wherein the splitters have a streamlined shape.

13. The apparatus of claim 11 wherein each of the splitters has an airfoil shape with spaced-apart pressure and suction sides extending between a leading edge and a trailing edge thereof.

14. The apparatus of claim 11 wherein at least one of the spaces has two or more of the splitters positioned therein.

15. The apparatus of claim 14 wherein each of the struts has an airfoil shape with spaced-apart pressure and suction sides extending between a leading edge and a trailing edge thereof.

16. The apparatus of claim 15 wherein the splitters within the at least one space have a variable size, with the chord decreasing as the splitters extend further away from the suction side of one of the struts.

17. The apparatus of claim 11 wherein the splitter airfoils are positioned such that their leading edges are located within a range extending from approximately 15% of the chord dimension of the struts axially forward of the strut leading edges, to approximately 30% of the chord dimension of the struts axially rearward of the strut leading edges.

18. The apparatus of claim 11 wherein the span dimension of at least one of the splitter airfoils is 50% or less of the span dimension of the corresponding struts.

19. The apparatus of claim 11 wherein the chord dimension of at least one of the splitter blades at the tips thereof is 50% or less of the chord dimension of the corresponding struts at the tips thereof.

20. The apparatus of claim 11 wherein:
the support structure comprises a hub surrounded by an annular casing;
the struts extend between the hub and the casing; and
the splitters extend from the casing.
